(19) United States
(12) Patent Application Publication
(10) Pub. No.: US 2016/0299999 A1
(43) Pub. Date: Oct. 13, 2016

(54) SYSTEMS AND METHODS FOR POWER PLANT MODEL OPTIMIZATION

(71) Applicant: General Electric Company, Schenectady, NY (US)

(72) Inventors: Golda James, San Ramon, CA (US); Hun-Jin Kim, San Ramon, CA (US); Rajani Gundimeda, San Ramon, CA (US); Sabina Volkov, San Ramon, CA (US)

(21) Appl. No.: 14/682,873

(22) Filed: Apr. 9, 2015

(51) Int. Cl. G06F 17/50

(52) U.S. Cl. CPC G06F 17/5009

(57) ABSTRACT

Aspects of the present disclosure involve a system comprising a computer-readable storage medium storing at least one program, and a method for simulating performance of a power plant using predefined power plant models. In example embodiments, the method may include receiving user input specifying a power plant type from a plurality of power plant types. A predefined power plant model corresponding to the user specified power plant type is then accessed from a repository of predefined power plant models. A simulation is then performed using the predefined power plant model, and a report that summarizes the simulation is then generated and presented.

### TECHNICAL FIELD

The subject matter disclosed herein relates to power plants. In particular, example embodiments may relate to techniques for modeling a power plant.

### BACKGROUND

Traditional power plant performance modeling software helps users to predict performance of a variety of power plant types such as combined cycle plants, fossil boiler plants, nuclear power plants, cogeneration systems, combined heat-and-power plants, and advanced gas turbine cycle systems, for example. Conventional power plants comprise a variety of different physical machinery and components (referred to as “assets”) that work in concert to produce a power output. The traditional approach to modeling new power plants requires users to specify each individual asset in the power plant, the properties of each asset, and the relationships between assets. The complexity of these power plant systems often requires considerable time to configure the properties and relationships of each asset for modeling. Further, the complexity of modeling these systems often results in users encountering numerous errors that must be fixed before the model can be used to predict performance of the power plant. Accordingly, the traditional approach to modeling power plants can be a time consuming and costly process.

### BRIEF DESCRIPTION OF THE DRAWINGS

Various ones of the appended drawings merely illustrate example embodiments of the present inventive subject matter and cannot be considered as limiting its scope.

FIG. 1 is a block diagram illustrating various functional components of a power plant modeling application, consistent with some embodiments.

FIG. 2 is a diagrammatic representation of a machine in the example form of a computer system within which a set of instructions for causing the machine to perform any one or more of the methodologies discussed herein may be executed.

FIG. 3 is a flow chart illustrating a method for simulating performance of a power plant using a predefined power plant model, according to some embodiments.

FIG. 4 is a block diagram illustrating a data structure of a predefined power plant model, consistent with some embodiments.

FIG. 5 is an interface diagram illustrating a portion of a user interface for presenting a report including a list of performance metric values resulting from simulating performance of a power plant, consistent with some embodiments.

FIG. 6 is a flow chart illustrating a method for simulating performance of a power plant using a modified power plant model, according to some embodiments.

FIG. 7 is a flow chart illustrating a method for simulating performance of a power plant using a power plant model created from multiple predefined power plant models, according to some embodiments.

FIG. 8 is a network architecture diagram depicting a network system having a client-server architecture configured for exchanging data over a network, consistent with some embodiments.

FIG. 9 is a flowchart illustrating a method for generating a predefined power plant model repository, consistent with some embodiments.

### DETAILED DESCRIPTION

Reference will now be made in detail to specific example embodiments for carrying out the inventive subject matter. Examples of these specific embodiments are illustrated in the accompanying drawings, and specific details are set forth in the following description in order to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

Aspects of the present disclosure involve providing predefined template models for a variety of different types of power plants. By providing predefined power plant models, the number of man hours needed to model and simulate performance of power plants is reduced, and the amount of errors in power plant modeling is also reduced, which collectively decreases the time to market for new power plants. These predefined template models may be based on minimal existing models and may be fully editable by users. Further, these templates are predefined in that they have pre-filled calculations and optimized values for asset properties, options, positioning, and other relative values that may be based on user preferences.

Example embodiments involve a system and method for simulating performance of a power plant using a predefined power plant model. Consistent with some embodiments, the method may include providing a user interface that allows a user to specify a power plant type (e.g., a nuclear plant, a steam plant, a gas plant, or a combined cycle plant) and, in some instances, one or more user constraints (e.g., a desired energy output). Upon receiving user input entered via the user interface, the system accesses a predefined power plant model corresponding to the power plant type and the one or more constraints, if applicable. The predefined power plant model is a data structure that comprises data that describes each asset included in power plants of the type specified by the user input. For example, a predefined power plant model for a nuclear plant would include data that describes at least a radioactive reactor.

The method further includes providing a graphical representation of the predefined power plant model in the user interface presented to the user, and providing graphical elements (e.g., buttons, sliders, etc.) that allow the user to edit aspects of the model (e.g., add or remove assets, change asset properties, or reconfigure asset relationships). Once the user has edited the model to his satisfaction, the user may cause the system to execute the power plant model (e.g., simulate performance of the power plant). Upon executing the power plant model, the system generates a report to summarize the results of the execution of the model.

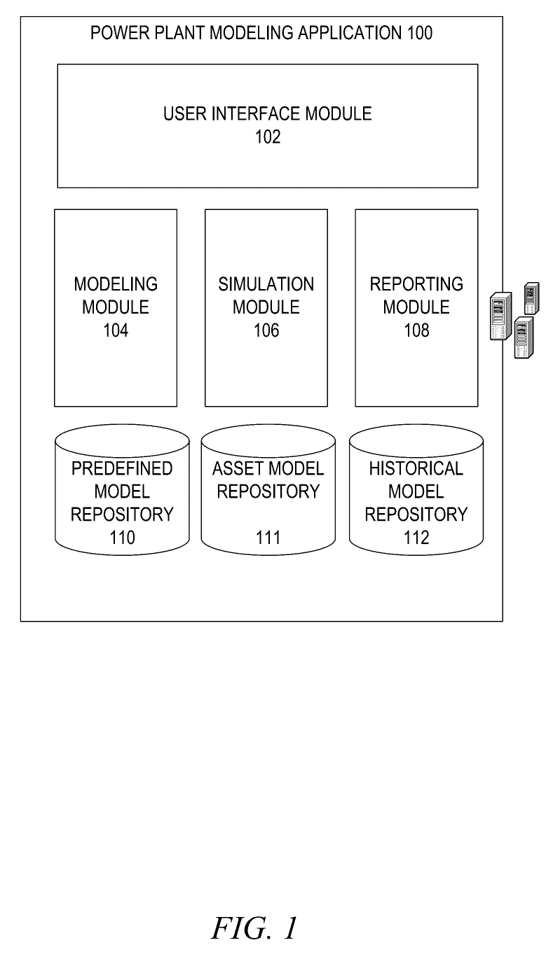

FIG. 1 is a block diagram illustrating various functional components of a power plant modeling application 100, consistent with some embodiments. To avoid obscuring the inventive subject matter with unnecessary detail, various functional components (e.g., modules and engines) that are not germane to conveying an understanding of the inventive subject matter have been omitted from FIG. 1. However, a skilled artisan will readily recognize that various additional functional components may be supported by the power plant modeling application 100 to facilitate additional functionality that is not specifically described herein.

As is understood by skilled artisans in the relevant computer arts, the modules and engines illustrated in FIG. 1 represent a set of executable software instructions and the corresponding hardware (e.g., memory and processor) for executing the instructions. Furthermore, the various functional components depicted in FIG. 1 may reside on a single computer (e.g., a laptop), or may be distributed across several computers in various arrangements such as cloud-based architectures. Moreover, it shall be appreciated that while the functional components (e.g., modules and engines) of FIG. 1 are discussed in the singular sense, in other embodiments, multiple instances of one or more of the modules may be employed.

As illustrated in FIG. 1, the power plant modeling application 100 includes a user interface module 102, a modeling module 104, a simulation module 106, and a reporting module 108, all configured to be in communication with each other (e.g., via a bus, a shared memory, a network, or a switch) so as to allow information to be passed between the functional components or so as to allow the functional components to share and access common data. Additionally, each of the functional components illustrated in FIG. 1 may access and retrieve data from a predefined model repository 110, an asset model repository 111, or a historical power plant model repository 112.

As shown, the power plant modeling application 100 is generally based on three-layer software architecture, consisting of a front-end layer, a logic layer, and a data layer, although the inventive subject matter is by no means limited to such architecture. The presentation layer consists of the user interface module 102 that is responsible for presenting information and handling user interactions related to the functions of the power plant modeling application 100. Accordingly, the interface module 102 may provide a number of interfaces to users (e.g., interfaces that are presented on a computing system operated by the user) that allow the users to view, create, and edit power plant models. To this end, the interfaces provided by the user interface module 102 may include one or more graphical interface elements (e.g., buttons, toggles, switches, drop-down menus, or sliders) that may be manipulated through user input to perform various operations associated with modeling power plants. For example, the user interface module 102 may provide an interface element that allows users to identify and select a power plant type and in some instances, a subtype, corresponding to the power plant the user wishes to model. In some instances, the user interface module 102 may also provide an additional element that allows users to specify one or more constraints for the power plant that may affect the assets included in the power plant to be modeled. In another example, the interface module 102 may provide elements that allow users to add or remove assets to a power plant model, adjust properties of the assets, and adjust or reconfigure the relationships between assets. The interface module 102 also receives and processes user input received through such interface elements.

The application layer of the power plant modeling application 100 includes the modeling module 104, the simulation module 106, and the reporting module 108. The modeling module 104 is responsible for predefined model selection, original model creation, and model modifications. The modeling module 104 accesses the predefined power plant model repository 110 and selects one or more models based on the power plant type and subtype relating to the plant that the user intends to model. In some embodiments, the predefined power plant model accessed by the modeling module 104 depends on other user constraints (e.g., a desired energy output)

The modeling module 104 also allows users to create new power plant models using existing asset models stored in the existing model repository 112, or combinations of predefined power plant models stored in the predefined model repository 110. For example, upon receipt of a user selection of multiple power plant types or subtypes, the modeling module 104 may access, select, and merge multiple predefined models resulting in an aggregated power plant model having attributes (e.g., assets, asset properties, and asset relationships) from each of the multiple predefined models. Further, in some instances, the modeling module 104 may map a power plant model (user generated or predefined) to a geographical location so as to enable structural modifications to the model to mimic the real-world power plant.

The simulation module 106 is configured to simulate performance of a power plant using a power plant model (e.g., a predefined power plant model). The simulation of the power plant may include creating a set of equations corresponding to common performance metrics for the power plant model (e.g., ambient temperature, ambient pressure, net cycle power, generator losses, generator output, total lower heating value, etc.), and solving the set of equations to generate values for the performance metrics.

The reporting module 108 is responsible for generating reports to summarize the results of the simulation of the performance of the power plant. Accordingly, the reports generated by the reporting module 108 include a list of performance metrics and values corresponding to each metric. The reporting module 108 may work in conjunction with the user interface module 102 to present the reports to users (e.g., to cause the reports to be displayed by computing devices operated by the users).

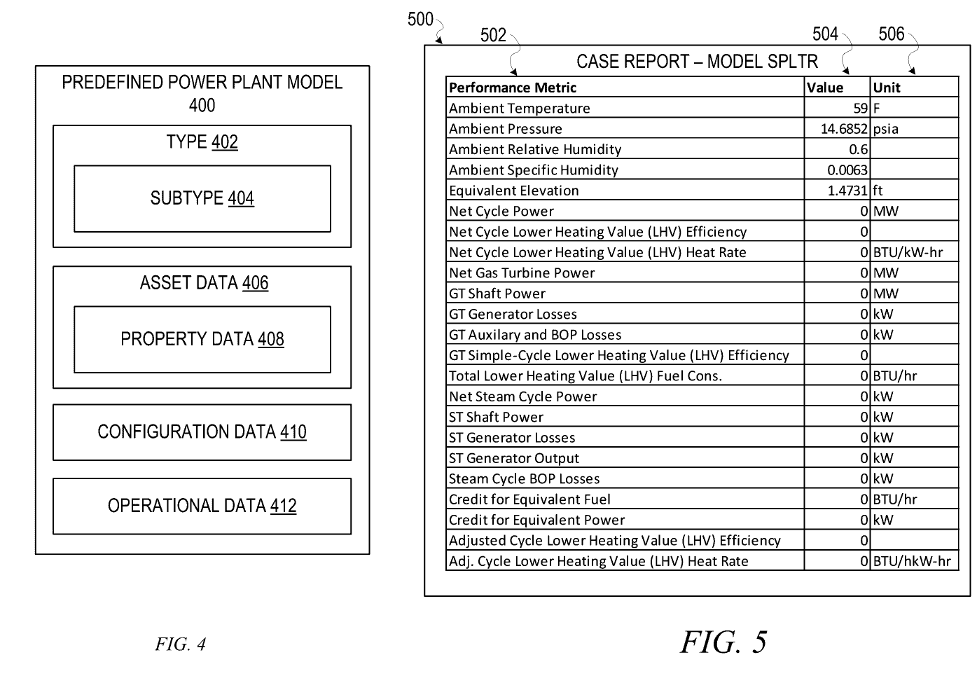

The data layer of the power plant modeling application 100 includes a predefined model repository 110 for storing predefined power plant models, an asset model repository 111 for storing models of power plant assets, and a historical power plant model repository 112 for storing previous user generated power plant models. Each of the models stored in the repositories 110-112 comprise structured data that represent one or more real-world components (e.g., power plants and power plant assets). Further details regarding the structure of predefined power plant models are discussed below in reference to FIG. 4.

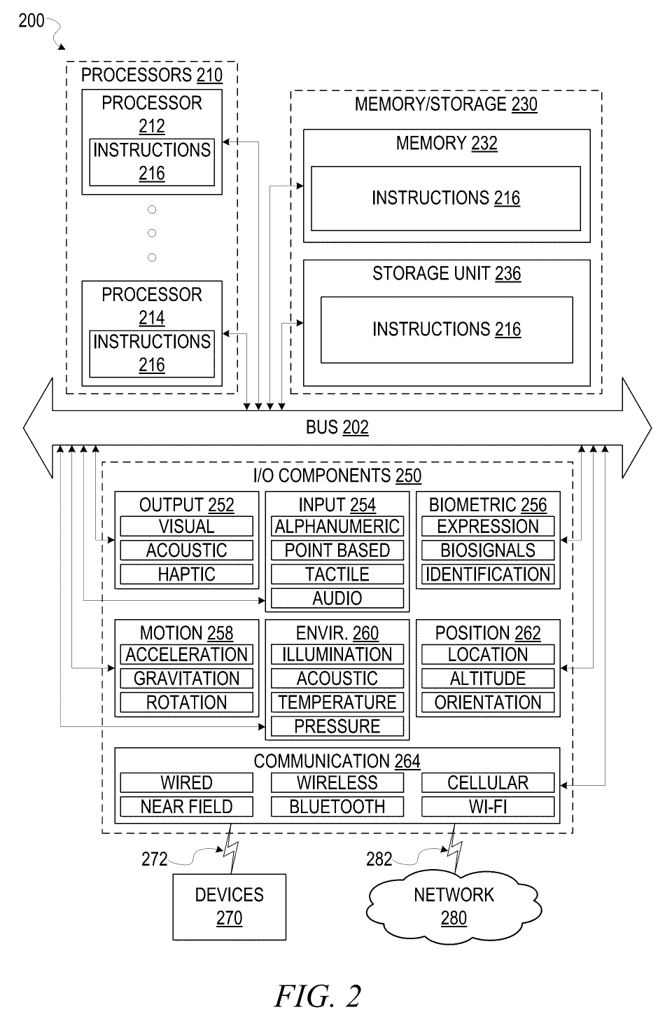

FIG. 2 is a block diagram illustrating components of a machine 200, according to some example embodiments, able to read instructions from a machine-readable medium (e.g., a machine-readable storage medium) and perform any one or more of the methodologies discussed herein. Specifically, FIG. 2 shows a diagrammatic representation of the machine 200 in the example form of a computer system, within which instructions 216 (e.g., software, a program, an application, an applet, an app, or other executable code) for causing the machine 200 to perform any one or more of the methodologies discussed herein may be executed. For example, the instructions 216 include executable code that cause the machine 200 to execute the power plant modeling application 100 and the associated functionalities described herein. These instructions transform the general, non-programmed machine into a particular machine programmed to carry out the described and illustrated functions of the power plant modeling application 100 in the manner described herein. The machine 200 may operate as a standalone device or may be coupled (e.g., networked) to other machines. In a networked deployment, the machine 200 may operate in the capacity of a server machine or a client machine in a server-client network environment, or as a peer machine in a peer-to-peer (or distributed) network environment. By way of non-limiting example, the machine 200 may comprise or correspond to a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 216, sequentially or otherwise, that specify actions to be taken by machine 200. Further, while only a single machine 200 is illustrated, the term “machine” shall also be taken to include a collection of machines 200 that individually or jointly execute the instructions 216 to perform any one or more of the methodologies discussed herein.

The machine 200 may include processors 210, memory 230, and input/output (I/O) components 250, which may be configured to communicate with each other such as via a bus 202. In an example embodiment, the processors 210 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 212 and processor 214 that may execute instructions 216. The term “processor” is intended to include multi-core processor that may comprise two or more independent processors (sometimes referred to as “cores”) that may execute instructions contemporaneously. Although FIG. 2 shows multiple processors, the machine 200 may include a single processor with a single core, a single processor with multiple cores (e.g., a multi-core process), multiple processors with a single core, multiple processors with multiples cores, or any combination thereof.

The memory/storage 230 may include a memory 232, such as a main memory, or other memory storage, and a storage unit 236, both accessible to the processors 210 such as via the bus 202. The storage unit 236 and memory 232 store the instructions 216 embodying any one or more of the methodologies or functions described herein. The storage unit 236 may also store the predefined model repository 110, the asset model repository 111, and the historical model repository 112. The instructions 216 may also reside, completely or partially, within the memory 232, within the storage unit 236, within at least one of the processors 210 (e.g., within the processor's cache memory), or any suitable combination thereof, during execution thereof by the machine 200. Accordingly, the memory 232, the storage unit 236, and the memory of processors 210 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 216. The term “machine-readable medium” shall also be taken to include any medium, or combination of multiple media, that is capable of storing instructions (e.g., instructions 216) for execution by a machine (e.g., machine 200), such that the instructions, when executed by one or more processors of the machine 200 (e.g., processors 210), cause the machine 200 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 250 may include a wide variety of components to receive input, provide output, produce output, transmit information, exchange information, capture measurements, and so on. The specific I/O components 250 that are included in a particular machine will depend on the type of machine. For example, portable machines such as mobile phones will likely include a touch input device or other such input mechanisms, while a headless server machine will likely not include such a touch input device. It will be appreciated that the I/O components 250 may include many other components that are not shown in FIG. 2. The I/O components 250 are grouped according to functionality merely for simplifying the following discussion and the grouping is in no way limiting. In various example embodiments, the I/O components 250 may include output components 252 and input components 254. The output components 252 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 254 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 250 may include biometric components 256, motion components 258, environmental components 260, or position components 262 among a wide array of other components. For example, the biometric components 256 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 258 may include acceleration sensor components (e.g., accelerometer), gravitation sensor components, rotation sensor components (e.g., gyroscope), and so forth. The environmental components 260 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 262 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 250 may include communication components 264 operable to couple the machine 200 to a network 280 or devices 270 via coupling 282 and coupling 272, respectively. For example, the communication components 264 may include a network interface component or other suitable device to interface with the network 280. In further examples, communication components 264 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 270 may be another machine or any of a wide variety of peripheral devices (e.g., a peripheral device coupled via a Universal Serial Bus (USB)).

Moreover, the communication components 264 may detect identifiers or include components operable to detect identifiers. For example, the communication components 264 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 264, such as, location via Internet Protocol (IP) geo-location, location via Wi-Fi® signal triangulation, location via detecting a NFC beacon signal that may indicate a particular location, and so forth.

In various example embodiments, one or more portions of the network 280 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 280 or a portion of the network 280 may include a wireless or cellular network and the coupling 282 may be a Code Division Multiple Access (CDMA) connection, a Global System for Mobile communications (GSM) connection, or other type of cellular or wireless coupling. In this example, the coupling 282 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 216 may be transmitted or received over the network 280 using a transmission medium via a network interface device (e.g., a network interface component included in the communication components 964) and utilizing any one of a number of well-known transfer protocols (e.g., Hypertext Transfer Protocol (HTTP)). Similarly, the instructions 216 may be transmitted or received using a transmission medium via the coupling 272 (e.g., a peer-to-peer coupling) to devices 270. The term “transmission medium” shall be taken to include any intangible medium that is capable of storing, encoding, or carrying instructions 216 for execution by the machine 200, and includes digital or analog communications signals or other intangible medium to facilitate communication of such software.

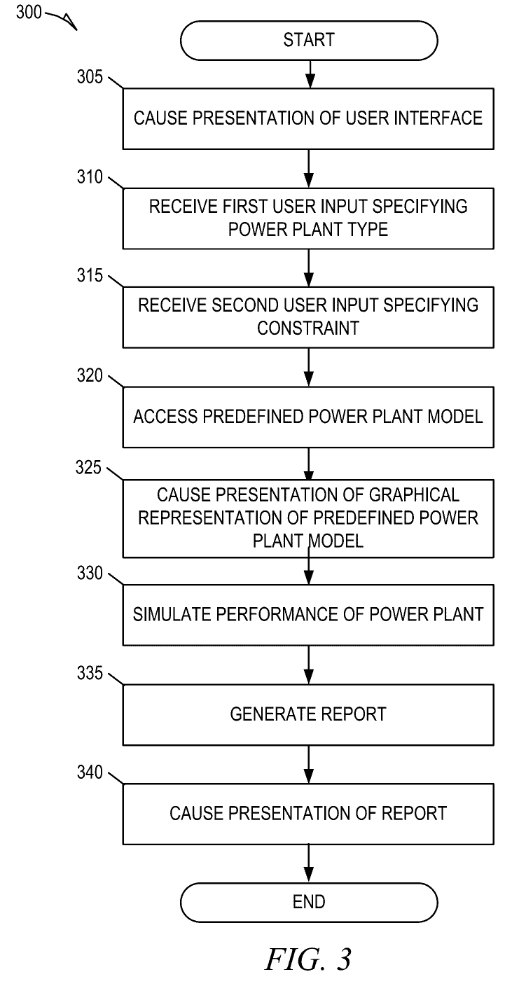

FIG. 3 is a flow chart illustrating a method 300 for simulating performance of a power plant using a predefined power plant model, according to some embodiments. The method 300 may be embodied in computer-readable instructions for execution by a hardware component (e.g., a processor) such that the operations of the method 300 may be performed by the computing system 200. In particular, the operations of the method 300 may be performed in part or in whole by the functional components forming the power plant modeling application 100, accordingly, the method 300 is described below, by way of example with reference thereto. However, it shall be appreciated that the method 300 may be deployed on various other hardware configurations and is not intended to be limited to the computing system 200.

At operation 305, the user interface module 102 causes presentation of a user interface on a display embedded in or coupled to the computing system 200. The user interface includes an interface element (e.g., a text input field or drop-down menu) configured to receive a user input specifying a power plant type. In some embodiments, the interface element allows a user to select a particular power plant type from a list of power plant types. The user interface may further include an additional interface element configured to receive an additional user input specifying a one or more constraints for the power plant (e.g., a desired energy output, a power plant subtype, or additional assets).

At operation 310, the user interface module 102 receives a first user input entered via the user interface using the user interface element. The first user input specifies a power plant type and may be a text entry or a user selection from a list of power plant types. At operation 315, the user interface module 102 may, in some embodiments, receive a second user input entered via the user interface using the additional user interface element. The second user input specifies the constraint for the power plant type specified at operation 310.

At operation 320, the modeling module 104 accesses a predefined power plant model from the predefined model repository 110. The predefined power plant model accessed by the modeling module 104 corresponds to the power plant type, and in some instances, the user constraint (e.g., a power plant subtype), specified by the user input. In other words, the modeling module 104 identifies and selects a particular predefined power plant model from the repository of predefined power plant models based on user input received by the user interface module 102. The predefined power plant model is a data structure that represents a power plant. More specifically, the predefined power plant model represents assets of the power plant, properties of each asset, and the relationships and configurations of the assets.

For example, FIG. 4 is a block diagram illustrating a data structure of a predefined power plant model 400, consistent with some embodiments. As shown, the predefined power plant model 400 comprises a number of attributes including type 402, subtype 404, asset data 406, property data 408, configuration data 410, and operational data 412. Although editable by users, the values associated with each of these attributes of the predefined power plant model 400 may be optimized based on an analysis of existing user generated models. The type 402 property describes the power plant type of the power plant (e.g., a nuclear plant, a steam plant, a gas plant, or a combined cycle plant), and the subtype 404 describes the subtype of the power plant type (e.g., a basic nuclear plant or an enhanced nuclear plant). The asset data 406 represents and describes each asset in the power plant represented by the predefined power plant model 400, and includes property data 408 describing properties of each asset. Each asset type may have different sets of properties.

In some embodiments, the asset data 406 comprises one or more predefined models for the power plant assets (e.g., a data structure representing the asset). Depending on the power plant type, the asset data 406 may, for example, represent a generator, a gas turbine, a combustor, a fuel input control, combustor sensors, a flame detector, a compressor, or a condensate pump among many other such power plant assets. As an example, for a combustor, which is an asset included in certain types of power plants, the attribute data 406 may represent a temperature set point for the combustor. As another example, for a turbine, which is another type of asset included in certain types of power plants, the property data 406 may include a surface area of the turbine.

The configuration data 410 describes the relationships of the assets (e.g., the layout of and connections between assets) included in the power plant represented by predefined power plant model 400. The relationships represented by the configuration data 410 may be logical relationships, physical relationships, or a combination thereof. The operational data 412 describes aspects of the operation of the power plant including any operational parameters of the power plant system (e.g., energy output).

Referring back to FIG. 3, at operation 325, the user interface module 102 causes presentation of a graphical representation of the predefined power plant model (e.g., predefined power plant model 400) accessed by the modeling module 104 at operation 320. Accordingly, the graphical representation of the predefined power plant includes multiple graphical objects that represent the assets of the power plant and graphical elements that represent the relationships between the assets.

At operation 330, the simulation module 106 simulates performance of the power plant using the predefined power plant model. The simulating of the performance of the power plant may be in response to user input requesting simulation of the power plant. The simulating of the power plant may comprise creating a set of equations corresponding to common performance metrics for the predefined power plant model (e.g., ambient temperature, ambient pressure, net cycle power, generator losses, generator output, total lower heating value, etc.), and solving the set of equations to generate values for the performance metrics.

At operation 335, the reporting module 108 generates a report that summarizes the results of the simulation performed by the simulation module 106. The report may, for example, identify a list of performance metrics for the power plant, and provide a value for each performance metric. At operation 340, the user interface module 102 causes the report to be presented within an interface on a display embedded in or coupled to the computing system 200.

As an example, FIG. 5 is an interface diagram illustration a portion of a user interface for presenting a report 500 including a list of performance metric values resulting from simulating performance of a power plant, consistent with some embodiments. As shown, the report 500 includes a column 502 that provides a list of performance metrics relating to the performance of the power plant represented by the predefined power plant model. For each of the performance metrics included in column 502, a corresponding performance metric value is provided in column 504. Column 506 describes the unit of measurement corresponding to each performance metric included in the column 502.

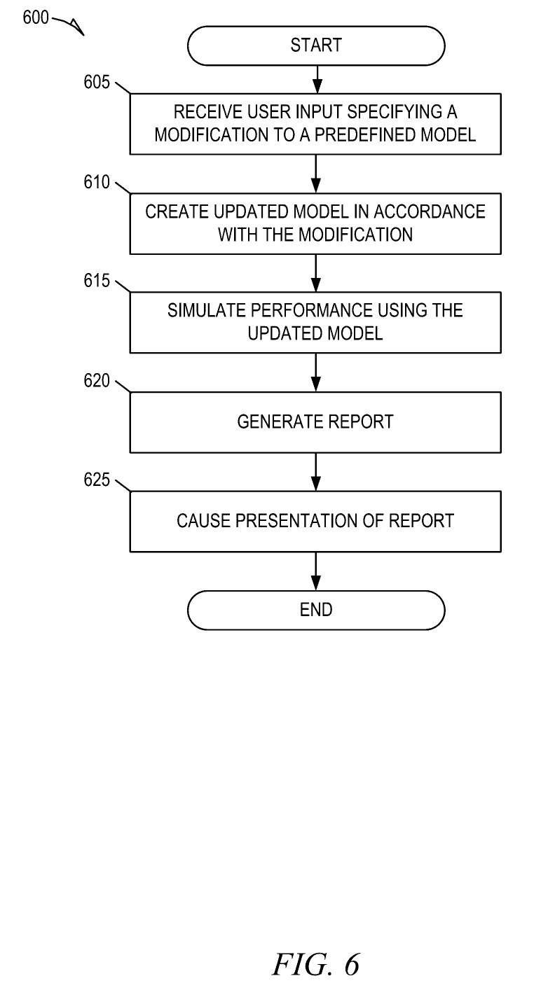

FIG. 6 is a flow chart illustrating a method 600 for simulating performance of a power plant using a modified power plant model, according to some embodiments. The method 600 may be embodied in computer-readable instructions for execution by a hardware component (e.g., a processor) such that the operations of the method 600 may be performed by the computing system 200. In particular, the operations of the method 600 may be performed in part or in whole by the functional components forming the power plant modeling application 100; accordingly, the method 600 is described below, by way of example with reference thereto. However, it shall be appreciated that the method 600 may be deployed on various other hardware configurations and is not intended to be limited to the computing system 200.

The method 600 may, in some embodiments, be initiated at the conclusion of method 300. At operation 605, the user interface module 102 receives user input specifying a modification to a predefined power plant model. The user input may be entered using one or more graphical interface elements (e.g., buttons, toggles, switches, drop-down menus, or sliders) that may be manipulated through user input. In some instances, the user input may include manipulation of one or more elements of a graphical representation of the predefined power plant model. The modification may, for example, include adding or removing an asset, adjusting an attribute of an asset, or reconfiguring a relationship between assets.

In some instances, the modification specified by the user may result in an error in the simulation of the power plant due to the configuration of other assets in the model being incompatible with the modification. Accordingly, the modeling module 104 may monitor the modifications made by the user to determine if such modifications are incompatible with other aspects of the model, and in such instances, the modeling module 104 may work in conjunction with the interface module 102 to provide the user with a notification of such incompatibility. In some instances, the notifications may include a suggestion for how to fix the incompatibility.

At operation 610, the modeling module 104 creates an updated power plant model in accordance with the user input. Depending on the modification specified by the user input, the creation of the updated power plant model performed by the modeling module 104 may include modifying asset data of the predefined power plant model to add a new asset to or remove an existing asset from the predefined power plant model, modifying attribute data of the predefined power plant model to change an attribute of an asset, or modifying configuration data to change the relationship between assets.

At operation 615, the simulation module 104 uses the updated power plant model to simulate performance of the power plant described by the updated power plant model. At operation 620, the report module 106 generates a report summarizing the results of the simulation. At operation 625, the interface module 102 causes the report to be presented (e.g., on a display embedded in or coupled to the computing system 200).

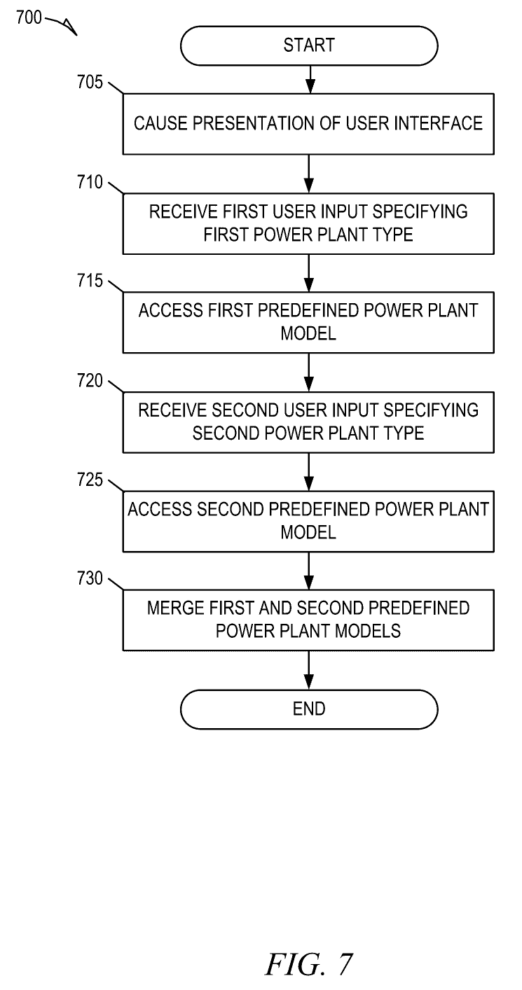

FIG. 7 is a flow chart illustrating a method for simulating performance of a power plant using a power plant model created from multiple predefined power plant models, according to some embodiments. The method 700 may be embodied in computer-readable instructions for execution by a hardware component (e.g., a processor) such that the operations of the method 700 may be performed by the computing system 200. In particular, the operations of the method 700 may be performed in part or in whole by the functional components forming the power plant modeling application 100; accordingly, the method 700 is described below, by way of example with reference thereto. However, it shall be appreciated that the method 700 may be deployed on various other hardware configurations and is not intended to be limited to the computing system 200.

At operation 705, the user interface module 102 causes presentation of a user interface (e.g., on a display embedded in or coupled to the computing system 200). The user interface includes interface elements (e.g., a text input field or drop-down menu) configured to receive a user input specifying a power plant type and, in some instances, a user constraint such as a subtype.

At operation 710, the user interface module 102 receives a first user input entered via the user interface using the user interface element. The first user input (e.g., a text entry or a user selection from a list of power plant types) specifies a first power plant type. At operation 715, the modeling module 104 accesses a first predefined power plant model from the predefined model repository 110 that corresponds to the first power plant type.

At operation 720, the user interface module 102 receives a second user input entered via the user interface using the user interface element. The second user input (e.g., a text entry or a user selection from a list of power plant types) specifies a second power plant type. At operation 725, the modeling module 104 accesses a second predefined power plant model from the predefined model repository 110 that corresponds to the second power plant type.

At operation 730, the modeling module 104 merges the first and second predefined power plant models to create a merged power plant model. The resulting merged power plant model comprises at least a portion of the attributes of the first predefined power plant model, and at least a portion of the attributes of the second predefined power plant model.

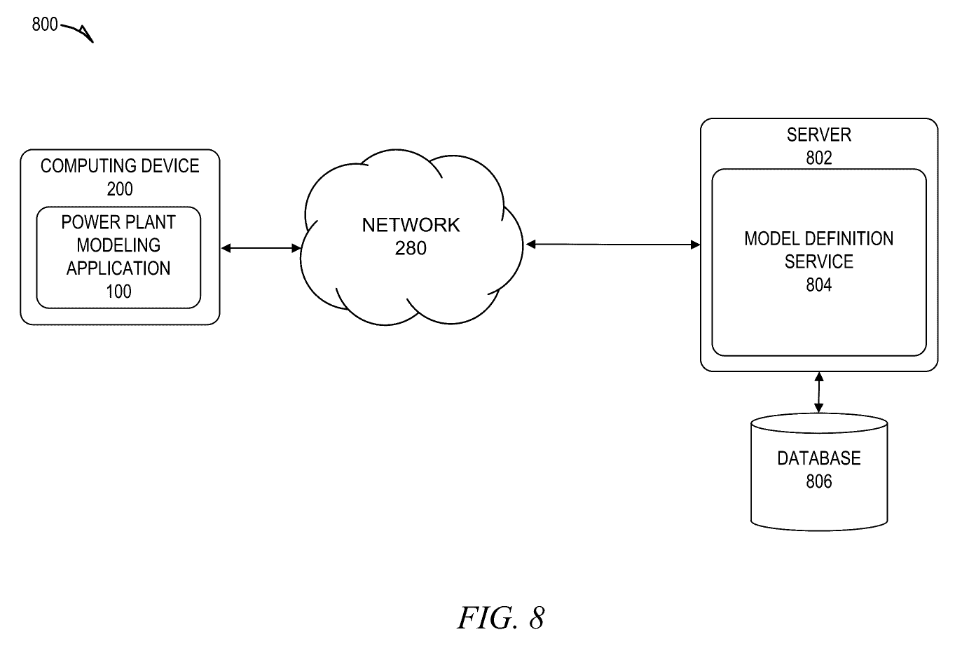

FIG. 8 is a network architecture diagram depicting a network system 800 having a client-server architecture configured for exchanging data over a network, consistent with some embodiments. While FIG. 8 provides an example architecture that is consistent with some embodiments, the presented inventive subject matter is not limited to the architecture illustrated in FIG. 8, and may equally well find application in a an event-driven, distributed, or peer-to-peer architecture system, for example. It shall also be appreciated that, although various components illustrated in FIG. 8 are discussed in the singular sense, multiple instances of one or more of the various functional components may be employed.

As shown, the network system 800 includes the computing system 200 in communication with a server 802 over the network 280. The server 802 communicates and exchanges data with the computing system 200 that pertains to various functions and aspects associated with the network system 800 and, in particular, the power plant modeling application 100. The computing system 200 may be operated by a user (e.g., a person) of the network system 800, and may likewise communicate and exchange data with the server 802 over the network 280. For example, the computing system 200 may transmit power plant models generated by users of the power plant modeling application 100 to the server 802 for recording and analysis.

The application server 112 hosts applications (e.g., web applications) and services that improve and optimize the functionality of the power plant modeling application 100. For example, the server 802 hosts a model definition service 804 configured to generate predefined models, and provide the predefined models to the computing system 200 for use with the power plant modeling application 100. The model definition service 804 may generate predefined power plant models using existing user generated power plant models (referred to herein as “historical power plant models” or simply as “historical models”).

The user generated historical models and the predefined power plant models generated by the model definition service 804 may be stored in a database 806 that is communicatively coupled to the server 802 (e.g., via wired or wireless interfaces). As with the predefined power plant models, the historical power plant models are data structures that represent power plants and include attributes related to the assets included in the power plant, the properties of assets, and the relationships of assets.

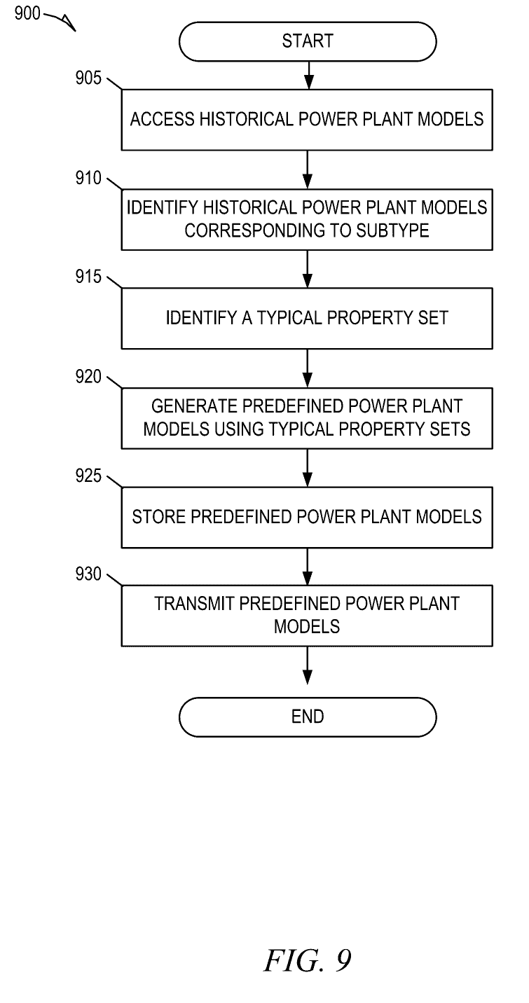

FIG. 9 is a flowchart illustrating a method 900 for generating a predefined power plant model, consistent with some embodiments. The method 900 may be embodied in computer-readable instructions for execution by a hardware component (e.g., a processor) such that the operations of the method 900 may be performed by the server 802. In particular, the operations of the method 900 may be performed in part or in whole by the model definition service 804; accordingly, the method 900 is described below, by way of example with reference thereto. However, it shall be appreciated that the method 700 may be deployed on various other hardware configurations and is not intended to be limited to the server 802.

At operation 905, the model definition service 804 accesses a corpus of historical power plant models that were previously generated by users of the power plant modeling application 100. Each of the historical power plant models describe and represent different types (and subtypes) of power plants of a different type and subtype. Each of the historical power plant models may include a property that describes the type and subtype of the power plant that is represented.

At operation 910, the model definition service 804 identifies a subset of historical power plant models that correspond to a particular subtype of power plant. The subset of historical power plant models may, for example, be identified using the type and subtype attributes. At operation 915, the model definition service 804 analyses the subset of historical power plant models to identify a typical property set for the particular subtype of power plant (e.g., a set of assets typically included in power plants of the subtype). The typical property set refers to an average set of attributes across all historical models corresponding to the subtype. The typical property set may be identified by identifying repeating patterns in the attributes of the subset of historical models.

At operation 920, the model definition service 804 generates a predefined power plant model using the typical property set. That is, the model definition service 804 generates a predefined power plant model that includes the typical property set.

At operation 925, the model definition service 804 stores the predefined power plant model in the database 806. At operation 930, the model definition service 804 provides the predefined power plant model to the computing system 200 for use with the power plant modeling application 100. Upon receiving the predefined power plant model, the power plant modeling application 100 stores the predefined power plant model in the predefined model repository 110. It shall be appreciated that the method 900 may be repeated for each possible power plant subtype. In this way, the method 900 may be used by the model definition service 804 to populate the predefined model repository 110 with a predefined power plant model for each possible power plant subtype. Further, the results of simulations of each of the historical power plant models may be maintained so as to allow creation of models that perform to certain user constraints.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field-programmable gate array (FPGA) or an ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network 102 (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site, or distributed across multiple sites and interconnected by a communication network 102.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Language

Although the embodiments of the present invention have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim.

What is claimed is:

1. A method comprising:
receiving a user input entered via a user interface, the user input specifying a power plant type from a plurality of power plant types;
accessing a predefined power plant model from a repository of predefined power plant models, the predefined power plant model corresponding to the power plant type specified by the user input, the predefined power plant model being a data structure comprising data describing a power plant;
simulating, by one or more processors of a machine, a plurality of performance metrics of the power plant using the predefined power plant model;
generating a report including a performance metric value for each of the performance metrics of the plurality of performance metrics; and
causing presentation of the report including the performance metric value for each of the performance metrics of the plurality of performance metrics.

2. The method of claim 1, further comprising:
receiving an additional user input specifying a modification to the predefined power plant model;
creating an updated power plant model, the creating of the updated power plant model including updating the predefined power plant model in accordance with the modification specified by the additional user input; and
simulating the plurality of performance metrics of the power plant using the updated power plant model.

3. The method of claim 2, wherein the modification to the predefined power plant model includes at least one from a group comprising: an additional asset being added, an existing asset being removed, a change in relationship between two or more assets, or a change to an attribute of an existing asset.

4. The method of claim 1, further comprising causing presentation of a user interface to receive the user input.

5. The method of claim 1, further comprising receiving an additional user input specifying a user constraint for the power plant type, wherein the predefined power plant model that is accessed is based on the user constraint.

6. The method of claim 1, further comprising causing presentation of a graphical representation of the predefined power plant model, the graphical representation of the power plant model including one or more graphical objects representing assets of the power plant.

7. The method of claim 1, further comprising
receiving a user selection of an additional power plant type;
accessing an additional predefined power plant model from the repository of predefined power plant models, the additional predefined power plant model corresponding to the additional power plant type; and
merging the predefined power plant model with the additional predefined power plant model to create a modified power plant model, the modified power plant model including a portion of data associated with the predefined power plant model and a portion of data associated with the additional predefined power plant model.

8. The method of claim 1, wherein the predefined power plant model comprises asset data and configuration data, the asset data specifying one or more assets included in the power plant and properties of the one or more assets, the configuration data specifying relationships between the one or more assets.

9. The method of claim 1, further comprising generating the predefined power plant model based on an analysis of historical power plant models.

10. The method of claim 9, wherein the generating of the predefined power plant model comprises:
accessing a plurality of historical power plant models, each of the historical power plant models being an existing user generated model;
identifying a subset of the plurality of historical power plant models corresponding to the power plant type specified by the user input;
identifying a typical property set for the subset of the plurality of power plant types, the typical property set including one or more typical attributes of the corresponding power plant type; and
using the typical property set to create the predefined power plant model.

11. A system comprising:
a processor of a machine; and
a machine-readable medium to store a repository of predefined power plant models, each of the predefined power plant models being data structures including data describing aspects of a power plant, the machine-readable medium further to store a set of instructions that cause the processor of the machine to implement:
a user interface module to receive a user input entered via a user interface, the user input specifying a power plant type from a plurality of power plant types;
a modeling module to access a particular predefined power plant model from the repository of predefined power plant models, the particular predefined power plant model corresponding to a power plant of the power plant type specified by the user input;
a simulation module to simulate a plurality of performance metrics of the power plant using the particular predefined power plant model;
a report module to generate a report including a performance metric value for each of the performance metrics of the plurality of performance metrics; and
the user interface module further to cause presentation of the report including the performance metric value for each of the performance metrics of the plurality of performance metrics.

12. The system of claim 11, wherein the power plant comprises a plurality of assets; and
wherein the predefined power plant model comprises a plurality of asset models, each of the plurality of asset models being a data structure that includes data describing an asset from the plurality of assets.

13. The system of claim 11, wherein the predefined power plant model comprises asset data and configuration data, the asset data specifying one or more assets included in the power plant and properties of the one or more assets, the configuration data specifying relationships between the one or more assets.

14. The system of claim 11, wherein the user interface module is further to receive an additional user input specifying a modification to the particular predefined power plant model,
wherein the modeling module is further to create an updated power plant model, the creating of the updated power plant model including updating the particular predefined power plant model in accordance with the modification specified by the additional user input; and
wherein the simulation module is further to simulate the plurality of performance metrics of the power plant using the updated power plant model.

15. The system of claim 14, wherein the modification to the predefined power plant model includes at least one from the group comprising: an additional asset being added, an existing asset being removed, a change in relationship between two or more assets, or a change to an attribute of an existing asset.

16. The system of claim 11, wherein the user interface module is further to cause presentation of the user interface to receive the user input specifying the power plant type from the plurality of power plant types.

17. The system of claim 11, wherein the user interface module is further to receive a user selection of an additional power plant type; and
wherein the modeling module is further to access an additional predefined power plant model corresponding to the additional power plant type, the modeling module further to merge the predefined power plant model with the additional predefined power plant model to create a modified power plant model, the modified power plant model including a portion of attributes associated with the predefined power plant model and a portion of attributes associated with the additional predefined power plant model.

18. The system of claim 11, wherein the user interface module is further to receive an additional user input specifying a subtype of the power plant type, wherein the particular predefined power plant model accessed by the modeling module corresponds to the subtype of the power plant type.

19. The system of claim 11, wherein the repository of predefined power plant models is generated based on existing user generated power plant models.

20. A non-transitory machine-readable storage medium embodying instructions that, when executed by at least one processor of a machine, cause the machine to perform operations comprising:
receiving a user input entered via user interface, the user input specifying a power plant type from a plurality of power plant types;
accessing a predefined power plant model from a repository of predefined power plant models, the predefined power plant model corresponding to the power plant type specified by the user input, the predefined power plant model being a data structure comprising data describing aspects of a power plant;
simulating, by one or more processors of a machine, a plurality of performance metrics of the power plant using the predefined power plant model;
generating a report including a performance metric value for each of the performance metrics of the plurality of performance metrics; and
causing presentation of the report including the performance metric value for each of the performance metrics of the plurality of performance metrics.
